(19) United States
(12) Patent Application Publication
(10) Pub. No.: US 2020/0056345 A1
(43) Pub. Date: Feb. 20, 2020

(54) Anti-blocking device for a field channel

(71) Applicant: Liying Mao, Taizhou City (CN)

(72) Inventor: Liying Mao, Taizhou City (CN)

(21) Appl. No.: 16/663,370

(22) Filed: Oct. 25, 2019

(30) Foreign Application Priority Data
Aug. 16, 2019 (CN) 2019107584976

(51) Int. Cl. E02F 5/28; B08B 1/00; E02B 5/08; F16H 1/16; F16H 7/02

(52) U.S. Cl. CPC E02F 5/28; B08B 1/005; F16H 7/02; F16H 1/16; E02B 5/08

(57) ABSTRACT

The invention discloses an anti-blocking device for a field channel, a fixed plate which is symmetrical back and forth, and comprises a front and back symmetry fixing plate, the lower end of the fixing plate can be fixed to the two sides of the canal channel of the canal, a transmission box is fixedly connected between the fixed plates on the two sides, a transmission device is arranged in the transmission box, and a cleaning device is arranged on the lower side of the transmission case, the device is simple in structure, a plurality of devices can be arranged on the canal channel, the cleaning efficiency is improved, the device can automatically clean the channel in the canal channel, avoid blockage of the channel after a long time, can collect sundries, and does not need manual cleaning, and the collected sundries are taken out by only human timing.

### CROSS-REFERENCES TO RELATED APPLICATIONS

The present application claims priority from Chinese application No. 2019107584976 filed on Aug. 16, 2019 which is hereby incorporated by reference in its entirety.

### TECHNICAL FIELD

The present invention relates to drainage channels field, in particular an anti-blocking device for a field channel

### BACKGROUND OF THE INVENTION

In some villages where water is inconvenient, there are channels for building water from the reservoir to the village to provide water for the people in the village, but the channels are generally built in the wild, and will accumulate in the channels after a long time, sandstone, leaves and other debris will accumulate in the channels, and then block the channel of the canal. In this case, manual channel cleaning is required. Due to the long length of the channel, it takes a lot of time to clean up, and the manual cleaning efficiency is low. The field channel anti-blocking device can solve the above problems. The invention has simple structure. Because the channel of the water channel is long, a plurality of the device of the invention can be arranged on the channel of the water channel to improve the cleaning efficiency, and the device can automatically carry out the debris in the channel of the channel. Clean up, avoid the blockage of the channel after a long time, and collect the sundries at the same time, no need to manually clean up, just need to take out the collected debris regularly.

### BRIEF SUMMARY OF THE INVENTION

Technical problem: after a long time, blockage will occur in the channel of the canal, and the efficiency of manual cleaning is slow.

In order to solve the above problems, this example designs a field channel anti-clogging device. In this example, a field channel anti-blocking device includes a front and rear symmetrical fixing plate, and the lower end of the fixing plate can be fixed on both sides of the channel, two A transmission box is fixedly connected between the fixing plates on the side, a transmission device is arranged in the transmission box, and a cleaning device is arranged on the lower side of the transmission box, and the cleaning device can be lowered into the water channel and The debris in the water channel is cleaned, the lower end of the transmission is screwed to the cleaning device, the transmission device is activated to drive the cleaning device to lift, and the fixing plate is provided with a storage device, and the cleaning device is After the debris in the channel is cleaned out, the garbage can be collected by the storage device, and the person only needs to clean out the debris in the storage device at a regular time, the operation is simple, the cleaning efficiency is fast, and the labor time is saved. Advantageously, the transmission device includes a transmission cavity disposed in the transmission case, a worm is rotatably disposed in the transmission cavity, a worm shaft is fixed in the worm, and an inner wall of the rear side of the transmission cavity is fixed a lifting motor is arranged, the rear end of the worm shaft is dynamically connected to the lifting motor, and the right end of the worm is meshed with a worm wheel, and the worm wheel is fixedly connected with a connecting shaft, and the lower side of the worm wheel is rotatably provided a driving pulley, the driving pulley is fixedly connected to the connecting shaft, a front side of the driving pulley is rotatably provided with a driven pulley, and a connection between the driving pulley and the driven pulley is a driving belt, a fixed shaft is fixedly connected to the driven pulley, a fan gear is fixed to a lower end of the fixed shaft, a pinion gear is meshed at a rear end of the fixed gear, and a screw is fixed to a lower end of the pinion gear. The lower end of the screw is screwed to the cleaning device, the lower end of the connecting shaft is fixed with a large gear, the large gear is located at the lower side of the driving pulley, and the large gear is provided with an opening downward groove. The upper end of the pinion extends into the engagement slot and can The large gear meshing connection is started, the lifting motor is started, and the worm is rotated by the worm shaft, thereby driving the worm wheel to rotate, and then the driving pulley and the large gear are rotated by the connecting shaft. The driving pulley drives the driven pulley to rotate synchronously through the driving belt, and further rotates the sector gear through the fixed shaft, so that the sector gear rotates at the same speed as the large gear and the steering is also the same. The sector gear can drive the pinion to rotate, and when the sector gear is disengaged from the pinion gear, the pinion gear meshes with the large gear wheel, and the large gear wheel can drive the pinion gear to rotate the pinion rotates and drives the cleaning device through the screw.

Advantageously, when the sector gear meshes with the pinion gear, the sector gear rotates and can rotate the pinion gear, thereby driving the cleaning device to descend by the screw, when the large gear is When the pinion gear is engaged, the large gear rotates and can drive the pinion to rotate, and then the cleaning device is driven to rise by the screw.

Advantageously, a gear ratio between the sector gear and the pinion gear is greater than a transmission between the large gear wheel and the pinion gear, and wherein the gear wheel drives the pinion gear to rotate at a higher speed than the sector gear The rotation speed of the pinion gear is driven, so that the cleaning device rises faster than the cleaning device decreases speed.

Advantageously, the cleaning device comprises a sliding rod disposed on a lower side of the transmission case, the sliding rod is provided with an upwardly threaded hole therein, and the lower end of the screw extends into the threaded hole and The sliding rod is screwed, the lower end of the sliding rod is fixedly connected with a connecting plate, the lower end of the connecting plate is fixedly connected with a left baffle, a fixed rod and a right baffle, and the left baffle is provided with a water passing hole And the water passing hole is penetrated in front and rear, a screen is fixed in the water passing hole, a water pipe is fixed in the fixing rod, and a tapered hole is arranged in the water pipe a groove extending to the right in the front and rear of the baffle is provided, and the inner wall of the left side of the groove is connected with five through grooves opening to the left, and the screw rotates and drives the sliding rod to move up and down, and further The connecting plate is driven to lift, and then the left baffle, the fixing rod and the right baffle are lifted and lowered.

Advantageously, the water flow sequentially flows through the groove, the through groove, the tapered hole, and the water passing hole, and the groove can collect a large volume of leaves and the like, sand and gravel, etc. Collecting a larger volume of sand and gravel soil to the right side of the screen through the through groove, the tapered hole, and the water passing hole, and screening through the screen, the tapered hole The diameter of the right opening is larger than the diameter of the left opening of the tapered hole, so that the flow rate increases when water flows through the tapered hole.

Advantageously, the right baffle is symmetrical in front and rear, and is provided with an open downward spring groove. The spring groove is slidably provided with a rack, and the upper end of the rack is fixed to the upper inner wall of the spring groove. The lower end of the rack extends to the outside of the spring slot, the left end of the spring slot is engaged with five connecting gears, and the connecting gears on the left and right sides are fixed with a rotating shaft, a rotating plate is disposed in the through slot, the rotating plate is fixed to the rotating shaft, and when the lower end of the right baffle is opposite to the bottom of the channel, the bottom of the channel pushes the rack to slide up, thereby driving the connection The gear rotates and compresses the spring, and the connecting gear drives the rotating plate to rotate and opens the through slot through the rotating shaft, and when the right baffle is out of contact with the bottom of the channel, under the elastic force of the spring The rack is driven to slide down, thereby driving the connecting gear to rotate, and then the rotating plate is rotated by the rotating shaft to close the through slot.

Advantageously, the accommodating device comprises a gear chamber disposed in the fixing plate on the front side, wherein the gear chamber is rotatably provided with a driving gear, and the driving gear is internally fixed with a motor shaft, the gear chamber A drive motor is fixed in the front inner wall, and the front end of the motor shaft is dynamically connected to the drive motor, and the left and right ends of the drive gear are symmetrically and meshed with a driven gear, and the driven gear is fixedly connected therein. a cantilever shaft, a rear side of the front side of the fixing plate is symmetrically disposed with a shovel plate, and the shovel plate is provided with an opening forward opening, the rear end of the cantilever shaft extends into the connecting hole and The shovel is screwed, and a push plate is fixedly connected to the right end of the shovel. The drive motor is activated, and the driving gear is rotated by the motor shaft to drive the driven gear to rotate. The cantilever shaft drives the blade to slide backward, so that the water passing hole and the debris in the groove can be scooped out, and the moving object is pushed by the pushing plate.

Advantageously, the fixing plate of the rear side is provided with a receiving cavity in a left-right direction, and a through hole is formed in the front inner wall of the front side of the receiving cavity, and the blade and the push plate can be the debris is pushed into the storage chamber and collected.

The invention has the advantages that the structure of the invention is simple, and because the channel of the water channel is long, a plurality of devices of the invention can be arranged on the channel of the water channel to improve the cleaning efficiency, and the device can automatically clean the debris in the channel of the water channel to avoid time. After a long time, the channel is blocked, and the debris can be collected. It does not need to be cleaned manually. It only needs to take out the collected debris at regular intervals.

### BRIEF DESCRIPTION OF THE DRAWINGS

For ease of description, the present invention is described in detail by the following specific embodiments and the accompanying drawings.

FIG. 1 is a schematic view showing the overall structure of a field channel anti-clogging device of the present invention;

FIG. 2 is an enlarged schematic view of “A” of FIG. 1;

FIG. 3 is a schematic structural view of the “BB” direction of FIG. 1;

FIG. 4 is a schematic structural view of the “CC” direction of FIG. 1;

FIG. 5 is a schematic structural view of the “DD” direction of FIG. 2;

FIG. 6 is a schematic structural view of the “EE” direction of FIG. 5.

### DETAILED DESCRIPTION OF THE INVENTION

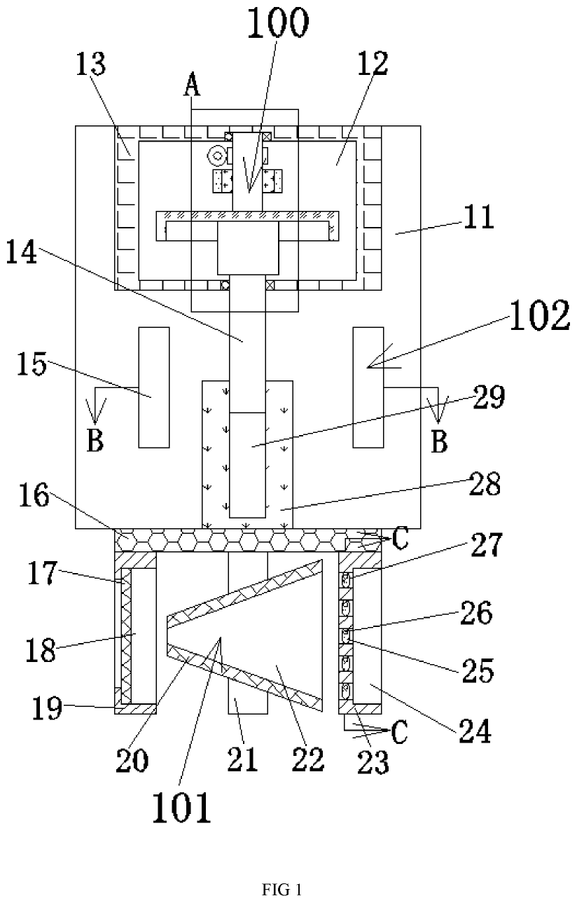

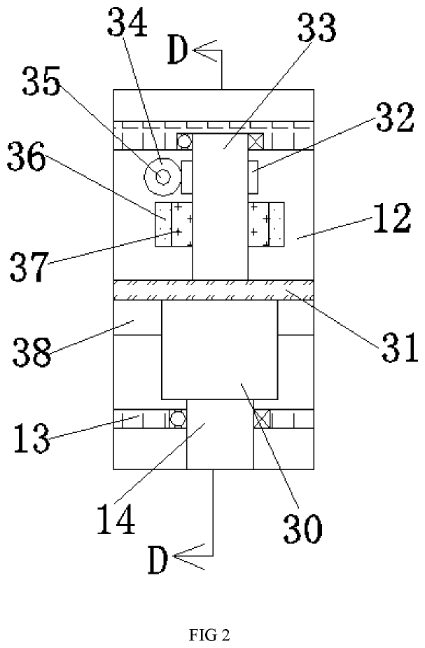

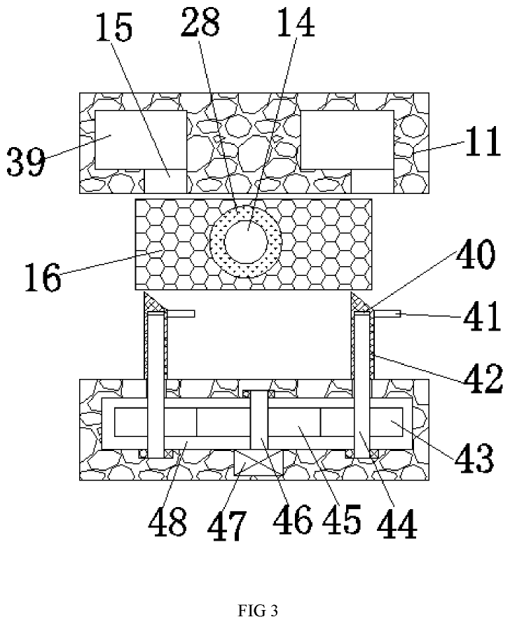

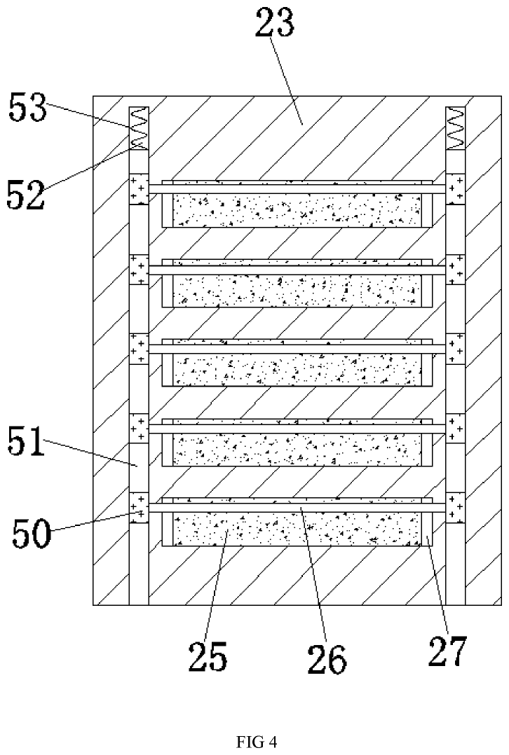

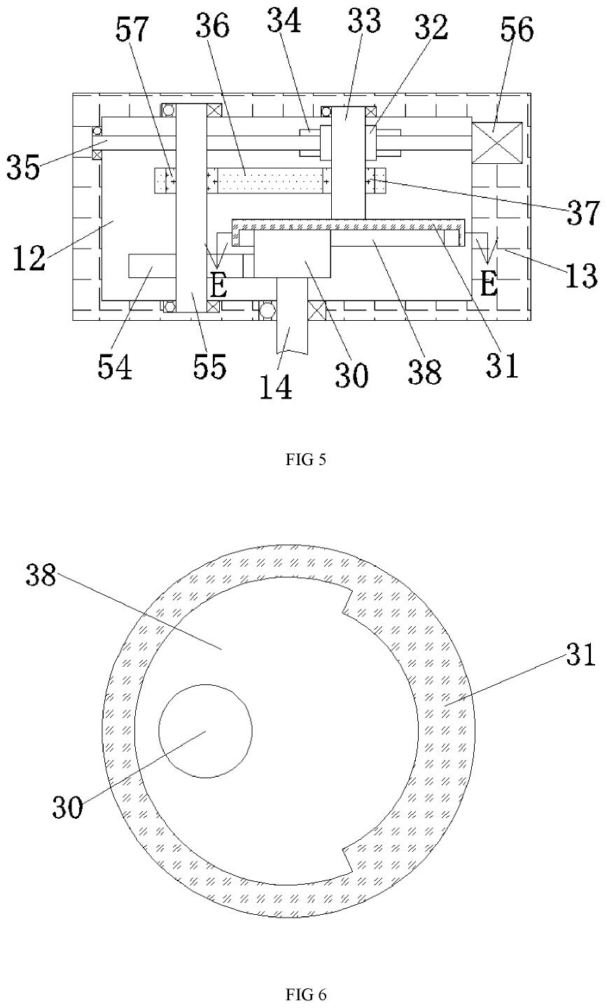

Below in connection with FIGS. 1-6 of the present invention will be described in detail, for the convenience of description, now follows a predetermined position on said below: around, below said vertical direction in FIG. 1 itself consistent relationship between the vertical and horizontal direction of projection.

The invention relates to a field channel anti-blocking device, which is mainly applied to the cleaning of debris in a field channel. The present invention will be further described below in conjunction with the drawings of the present invention:

The utility model relates to a field channel anti-blocking device, which comprises a front and rear symmetrical fixing plate 11, wherein the lower end of the fixing plate 11 can be fixed on two sides of the water channel, and the fixed plate 11 on both sides is fixedly connected with a transmission box 13, the gear box 13 equipped with gear 100, the gear box 13 the lower side is provided with vertically slidable cleaning device 101, the cleaning device 101 can be lowered into the canal and debris in the canal for In the cleaning, the lower end of the transmission device 100 is screwed to the cleaning device 101, the transmission device 100 is activated to lift the cleaning device 101, and the fixing device 11 is provided with a storage device 102. The cleaning device 101 is provided. After the debris in the channel is cleaned out, the garbage can be collected by the storage device 102, and the person only needs to clean out the debris in the storage device 102 at a regular time, and the operation is simple and the cleaning efficiency is fast. Save labor time.

According to an embodiment. Hereinafter, the detailed description of the transmission 100, the transmission 100 includes a transmission chamber 13 disposed within the transmission case 12, the transmission chamber 12 is provided with a rotatable worm 34, the A worm shaft 35 is fixed in the worm 34, and a lifting motor 56 is fixed in the inner wall of the rear side of the transmission chamber 12. The rear end of the worm shaft 35 is dynamically connected to the lifting motor 56, and the right end of the worm 34 is engaged. A worm wheel 32 is disposed, and a connecting shaft 33 is fixedly connected to the worm wheel 32. A locating pulley 37 is rotatably disposed on a lower side of the worm wheel 32. The driving pulley 37 is fixed to the connecting shaft 33. A driven pulley 57 is disposed on the front side of the driving pulley 37. A transmission belt 36 is connected between the driving pulley 37 and the driven pulley 57. The driven pulley 57 is fixedly fixed. a shaft 55, a fixed end of the fixed shaft 55 is fixed with a sector gear 54. The rear end of the fixed gear 54 is meshed with a pinion 30, and a screw 14 is fixed to a lower end of the pinion 30. Connected to the cleaning device 101, a large gear 31 is fixed to the lower end of the connecting shaft 33, and the large gear 31 is located at the lower side of the driving pulley 37 is provided with an opening downward engaging groove 38. The upper end of the pinion 30 extends into the engaging groove 38 and can be meshed with the large gear 31 to start. The lifting motor 56 further drives the worm 34 to rotate by the worm shaft 35, thereby driving the worm wheel 32 to rotate, and then the driving pulley 37 and the large gear 31 are rotated by the connecting shaft 33. The driving pulley 37 drives the driven pulley 57 to rotate synchronously through the driving belt 36, and then the fixed gear 55 drives the sector gear 54 to rotate, so that the sector gear 54 and the large gear 31 rotate. The same and the same steering, and the sector gear 54 can drive the pinion 30 to rotate. When the sector gear 54 is disengaged from the pinion 30, then the pinion 30 meshes with the large gear 31, at this time, the large gear 31 can drive the pinion 30 to rotate, and the pinion 30 rotates and drives the cleaning device 101 through the screw 14.

Advantageously, when the sector gear 54 is engaged with the pinion gear 30, the sector gear 54 rotates and can drive the pinion gear 30 to rotate, and then the cleaning device 101 is driven to descend by the screw 14 When the large gear 31 meshes with the pinion gear 30, the large gear 31 rotates and can rotate the pinion gear 30, and the cleaning device 101 is driven to rise by the screw 14.

Advantageously, the gear ratio between the sector gear 54 and the pinion gear 30 is greater than the transmission between the large gear 31 and the pinion 30, and the large gear 31 drives the pinion 30 to rotate. The rotation speed is greater than the rotation speed of the pinion gear 30 to drive the pinion gear 30, so that the cleaning device 101 ascends faster than the cleaning device 101.

According to an embodiment, the cleaning device 101 is described in detail below, and the cleaning device 101 includes a slidable sliding rod 28 disposed on a lower side of the transmission case 13, and the sliding rod 28 is provided with an opening upward thread a hole 29, a lower end of the screw rod 14 extends into the threaded hole 29 and is screwed to the sliding rod 28, a connecting plate 16 is fixed to lower end of the sliding rod 28, and a left side is fixed to the lower end of the connecting plate 16. The plate 19, the fixing rod 21 and the right baffle 23 are provided with a water-passing hole 18 in the left and right sides of the left baffle 19, and the water-passing holes 18 are penetrated back and forth, and the water-passing hole 18 is fixed with a sieve. In the net 17, a fixed water pipe 20 is fixedly connected to the fixing rod 21, and the water pipe 20 is provided with a tapered hole 22 extending through the left and right sides, and the right baffle 23 is provided with an opening to the right. 24, the inside of the inner wall of the left side of the recess 24 is connected with five through slots 27 opening to the left, the screw 14 rotates and drives the sliding rod 28 to lift and lower, thereby driving the connecting plate 16 to move up and down, and further The left baffle 19, the fixed rod 21, and the right baffle 23 are driven up and down.

Advantageously, the water flow sequentially flows through the groove 24, the through groove 27, the tapered hole 22, and the water passing hole 18, and the groove 24 can collect a large volume of leaves and the like. Sandstone soil or the like may pass through the through groove 27, the tapered hole 22, and the water passing hole 18, and be screened through the screen 17, and a larger volume of sand and gravel soil may be collected on the screen. On the right side of the 17th, the diameter of the right opening of the tapered hole 22 is larger than the diameter of the left opening of the tapered hole 22, so that the flow rate increases when water flows through the tapered hole 22.

Advantageously, the right baffle 23 is symmetrical in front and rear, and is provided with an open downward spring groove 52. The spring groove 52 is slidably provided with a rack 51, and the upper end of the rack 51 and the spring groove 52 are provided. A spring 53 is fixed between the upper inner wall, and the lower end of the rack 51 can extend outside the spring groove 52. The left end of the spring groove 52 is engaged with five connecting gears 50, and the left and right sides are A rotating shaft 26 is fixedly connected between the connecting gears 50. The rotating slot 25 is rotatably disposed in the through slot 27, and the rotating plate 25 is fixed to the rotating shaft 26 when the lower end of the right baffle 23 and the bottom of the channel At the same time, the bottom of the channel pushes the rack 51 to slide upward, thereby driving the connecting gear 50 to rotate and compressing the spring 53. The connecting gear 50 drives the rotating plate 25 to rotate by the rotating shaft 26 and opens the The through groove 27, when the right baffle 23 is out of contact with the bottom of the channel, the rack 51 is driven to slide down by the elastic force of the spring 53, thereby driving the connecting gear 50 to rotate, and then passing the rotating shaft 26 The rotating plate 25 is rotated to rotate and close the through groove 27.

According to an embodiment, hereinafter, the detailed description storage device 102, a storage device 102 within the gear chamber is provided comprising a front side 48 of the fixing plate 11, the gear cavity 48 is provided with a rotatable drive gear 45, a motor shaft 46 is fixed in the driving gear 45, and a driving motor 47 is fixed in the inner wall of the front side of the gear chamber 48. The front end of the motor shaft 46 is dynamically connected to the driving motor 47. The driven gear 43 is symmetrical and meshed at the left and right ends of the 45. The driven gear 43 is fixed with a cantilever shaft 44, and the rear side of the fixed plate 11 on the front side is symmetrically disposed with a blade 42. The blade 42 is provided with an opening forward opening 40. The rear end of the cantilever shaft 44 extends into the connecting hole 40 and is screwed to the blade 42. The right end of the blade 42 is fixedly connected. The driving plate 47 is activated by the driving plate 47, and the driving gear 45 is rotated by the motor shaft 46 to drive the driven gear 43 to rotate, and then the blade 42 is driven by the cantilever shaft 44. Rear sliding, thereby shoveling out the water hole 18 and the debris in the groove 24 And debris moved by pushing the push plate 41.

Advantageously, the fixing plate 11 on the rear side is provided with a receiving cavity 39 symmetrical in the left-right direction, and a through hole 15 having an opening forward is provided in the inner wall of the front side of the receiving cavity 39, the blade 42 and the push plate 41 can push the debris into the storage chamber 39 to collect it.

The following describes the steps of using the field channel anti-clogging device in the following with reference to FIG. 1 to FIG. 6:

Initially, the cleaning device 101 is located at the upper limit position, at which time the cleaning device 101 is located outside the channel, at which time the sector gear 54 meshes with the pinion 30, at which time the large gear 31 does not mesh with the pinion 30, and the lift motor 56 and the drive motor 47 set a certain start and stop time.

In use, the lifting motor 56 is activated, and the worm shaft 34 is rotated by the worm shaft 35, thereby driving the worm wheel 32 to rotate, and then the driving pulley 37 and the large gear 31 are rotated by the connecting shaft 33, and the driving pulley 37 is driven by the transmission belt 36. The pulley 57 rotates synchronously, and then the sector gear 54 is rotated by the fixed shaft 55, so that the sector gear 54 and the large gear 31 rotate at the same speed and the steering is also the same, and the sector gear 54 drives the pinion 30 to rotate, thereby driving the sliding rod 28 through the screw 14. Sliding, which in turn drives the connecting plate 16 to slide down, and then drives the left baffle 19, the fixed rod 21 and the right baffle 23 to slide down, when the lower end of the right baffle 23 abuts against the bottom of the channel, the bottom of the channel pushes the rack 51 to rise, thereby driving the connecting gear. 50 rotates and compresses the spring 53, and the connecting gear 50 rotates and drives the rotating plate 25 to rotate through the rotating shaft 26, thereby opening the through slot 27, at which time the lifting motor 56 is stopped, and the sector gear 54 is disengaged from the pinion 30 at this time, gear 31 immediately starts the engagement of the pinion 30, when the water flows through the groove 24, through slot 27, the tapered bore 22 and the water-passing hole 18, the groove 24 may be A large volume of leaves and other debris, sandstone soil, etc. can pass through the through groove 27, the tapered hole 22 and the water passing hole 18, and are screened through the screen 17, and the larger sandstone soil is collected in the screen. On the right side of the 17th, the diameter of the right opening of the tapered hole 22 is larger than the diameter of the left opening of the tapered hole 22, so that the flow rate is increased when water flows through the tapered hole 22.

After a period of time, the lifting motor 56 is further activated to drive the large gear 31 to rotate and drive the pinion 30 to rotate. At this time, the large gear 31 drives the pinion 30 to rotate faster than the sector gear 54 drives the pinion 30 to rotate, and then small. The gear 30 drives the sliding rod 28 to rise rapidly through the screw 14, thereby driving the connecting plate 16 to rise, thereby driving the left baffle 19, the fixing rod 21 and the right baffle 23 to rise, thereby causing the right baffle 23 to be separated from the bottom of the channel, at this time in the spring Under the elastic force of 53, the rack 51 is driven to slide down, thereby driving the connecting gear 50 to rotate, and then the rotating plate 25 is rotated by the rotating shaft 26 to close the through slot 27, and when the water passing hole 18 and the groove 24 are opposite to the through hole 15. The lifting motor 56, at this time, the large gear 31 and the pinion 30 are disengaged. At this time, the sector gear 54 just starts to mesh with the pinion 30. At this time, the driving motor 47 is activated, and then the driving gear 45 is driven to rotate by the motor shaft 46, thereby driving The movable gear 43 rotates, and the shovel 42 is slid by the cantilever shaft 44, and the debris in the water permeable hole 18 and the recess 24 can be shoveled, and the debris is pushed to the storage by the push plate 41. The chamber 39 is collected to reversely drive the drive motor 47 and disengage the blade 42 from the water passage 18 and the recess 24. At this time, the lift motor 56 is continuously activated and the cleaning device 101 is re-expanded into the channel for collecting debris.

People only need to clean out the debris in the storage chamber 39.

The invention has the advantages that the structure of the invention is simple, and because the channel of the water channel is long, a plurality of devices of the invention can be arranged on the channel of the water channel to improve the cleaning efficiency, and the device can automatically clean the debris in the channel of the water channel to avoid time. After a long time, the channel is blocked, and the debris can be collected. It does not need to be cleaned manually. It only needs to take out the collected debris at regular intervals.

In the above manner, those skilled in the art can make various changes depending on the mode of operation within the scope of the present invention.

1. A field channel anti-blocking device, which comprises a front and rear symmetrical fixing plate;
the lower end of the fixing plate can be fixed on two sides of the water channel, and a transmission box is fixedly connected between the fixing plates on the two sides, and the transmission box is provided with a transmission device, and a cleaning device is arranged on the lower side of the transmission box,
and the cleaning device can be lowered into the water channel and clean the debris in the water channel, and the lower end of the transmission device is screwed to the cleaning device The driving device can be driven to raise and lower the cleaning device;
the fixing plate is provided with a receiving device, and the cleaning device can collect the sundries in the channel, and the garbage can be collected by the receiving device, people only need to regularly clean out the debris in the storage device, the operation is simple, the cleaning efficiency is fast, and the labor time is saved.

2. A field channel anti-clogging device according to claim 1, wherein said transmission means comprises a transmission chamber provided in said transmission case, said transmission chamber being rotatably provided with a worm, said worm a worm shaft is fixedly disposed therein, and a lifting motor is fixed in an inner wall of the rear side of the transmission cavity, and a rear end of the worm shaft is dynamically connected to the lifting motor;
a worm wheel is disposed at a right end of the worm, and the worm wheel is disposed A connecting shaft is fixedly connected, and a driving pulley is disposed on a lower side of the worm wheel, the driving pulley is fixedly connected to the connecting shaft, and a driving pulley is rotatably disposed on a front side of the driving pulley. A transmission belt is connected between the driving pulley and the driven pulley, a fixed shaft is fixed in the driven pulley, a sector gear is fixedly connected to a lower end of the fixed shaft, and a rear end of the sector gear is engageable a pinion gear is disposed, a screw is fixed to a lower end of the pinion gear, and a lower end of the screw is screwed to the cleaning device;
a large gear is fixed to a lower end of the connecting shaft, and the large gear is located under the active pulley Side, the large gear is provided with an opening downward a slot, the upper end of the pinion extends into the engagement slot and is engageable with the large gear.

3. A field channel anti-clogging device according to claim 2, wherein when said sector gear meshes with said pinion gear, said sector gear rotates and can drive said pinion to rotate, thereby passing said The screw drives the cleaning device to descend. When the large gear meshes with the pinion gear, the large gear rotates and can drive the pinion gear to rotate, and then the cleaning device is driven to rise by the screw.

4. As claimed in claim in claim 3 in Field channel anti-clogging means, wherein:
the gear ratio between the pinion gear and the sector gear ratio between the large gear and the pinion is greater than, and thus the The rotation speed of the pinion gear to rotate the pinion gear is greater than the rotation speed of the pinion gear to drive the pinion gear, so that the cleaning device has a rising speed greater than the falling speed of the cleaning device.

5. A field channel anti-clogging device according to claim 2, wherein said cleaning device comprises a slidable sliding rod disposed on a lower side of said transmission box, said sliding rod having an opening upwardly threaded a hole, a lower end of the screw extends into the threaded hole and is screwed to the sliding rod, a lower end of the sliding rod is fixedly connected with a connecting plate, and a left baffle, a fixed rod and a right block are fixed to the lower end of the connecting plate a water passage hole is formed in the left and right sides of the left baffle plate, and the water passing hole is penetrated in front and rear, a screen mesh is fixed in the water passing hole, and a water pipe is fixed in the fixing rod. A tapered hole is formed in the through-water pipe, and a right-opening groove is formed in the right baffle. The inner wall of the left side of the groove is open to the left. Through the slot.

6. A field channel anti-clogging device according to claim 5, wherein water flow sequentially flows through said groove, said through groove, said tapered hole, and said water passing hole, said groove A large volume of leaves and the like can be collected, and the sandstone soil or the like can pass through the through groove, the tapered hole, and the water passing hole, and can be screened through the screen to form a larger volume of sand and gravel. The soil is collected on the right side of the screen, and the diameter of the right opening of the tapered hole is larger than the diameter of the left opening of the tapered hole, so that the flow rate increases when the water flows through the tapered hole.

7. A field channel anti-clogging device according to claim 6, wherein the right baffle is symmetrical in front and rear, and is provided with a spring groove having an opening downward, and the spring groove is slidably provided with a rack. A spring is fixed between the upper end of the rack and the inner wall of the upper side of the spring groove, the lower end of the rack extends to the outside of the spring slot, and the left end of the spring slot is engaged with five connecting gears. A rotating shaft is fixedly connected between the connecting gears on the two sides, and a rotating plate is rotatably disposed in the through slot, and the rotating plate is fixed to the rotating shaft.

8. A field channel anti-clogging device according to claim 1, wherein said receiving device comprises a gear chamber disposed in said fixed plate on the front side, wherein said gear chamber is rotatably provided with a driving gear a drive shaft is fixed in the driving gear, a driving motor is fixed in the inner wall of the front side of the gear cavity, and the front end of the motor shaft is dynamically connected to the driving motor; the left and right ends of the driving gear are symmetric and meshed The driven gear is provided with a cantilever shaft, and the rear side of the front side of the fixed plate is symmetrically disposed with a blade, and the blade is provided with an opening connecting hole in the front. The rear end of the cantilever shaft extends into the connecting hole and is screwed to the blade, and a push plate is fixed to the right end of the blade.

9. The field channel anti-clogging device according to claim 8, wherein the fixing plate on the rear side is provided with a storage cavity in a bilaterally symmetrical manner, and an opening is provided in the inner wall of the front side of the receiving cavity, the front through hole, the shovel and the push plate can push debris into the storage cavity to collect.
